(19) United States
(12) Patent Application Publication
(10) Pub. No.: US 2009/0158314 A1
(43) Pub. Date: Jun. 18, 2009

(54) TELEVISION FEATURE DISPLAY SYSTEM

(76) Inventor: Suni Flynn, Laguna Niguel, CA (US)

Correspondence Address: ORRICK, HERRINGTON & SUTCLIFFE, LLP;IP PROSECUTION DEPARTMENT, 4 PARK PLAZA, SUITE 1600, IRVINE, CA, 92614-2558, US

(21) Appl. No.: 11/958,255

(22) Filed: Dec. 17, 2007

(51) Int. Cl. H04N 7/10; H04N 5/50

(52) U.S. Cl. 725/32; 348/569; 348/E05.097

(57) ABSTRACT

Systems and methods for effectively displaying product features in a point of purchase environment to draw the attention of the consumer the manufacturer's television. In one embodiment, the features are stored in memory on the television as individual images, in one or more slideshows, in one or more videos, or the like, and are displayed on the screen as an overlay or secondary video with the primary video, which is typically the display of a common broadcast signal sent to multiple televisions in a store display. The television's on-screen-display controller combines the videos for display on the screen. The feature images can be displayed as a group label, as static images that fade in and out, as a dynamically rolling string of images or the like.

### FIELD

The present invention relates generally to televisions and, more particularly, to systems and methods that facilitate the display of product features in a point of purchase environment.

### BACKGROUND

Television sales continue to become more and more competitive as the capabilities and the features of televisions continue to expand and improve. Televisions, like most other consumer electronic products, are typically sold in a consumer electronics store or a consumer electronics department of a large department store. As depicted in FIG. 1, a typical television display 5 in the consumer electronics store or consumer electronics department has televisions from multiple manufactures positioned side by side on multiple display shelves. The consumer C typically sees the same program being displayed on each of the televisions as the same program signal is broadcast to each of the televisions. As a result, it is difficult for the consumer C to distinguish one manufacturer's television from another.

In order to distinguish their television and call the consumer C's attention to the features on their televisions, manufactures often include a point-of-sale (POP) feature label 16 attached to the face 14 of their television 10 just below the screen 12 as shown in FIG. 2. As depicted in FIG. 2a, the POP label typically includes the newest, most sought after features, e.g., 1080P, 6 Color, x.v.Color™, 4HDMI™, and Smooth 120 Hz. Creating and applying such labels to each of the manufacturer's televisions is time and labor intensive and, thus, costly.

One option to eliminate the need for such a label would be to include such features in a demonstration video often included in the memory of many televisions and displayed as the primary video on the screen of the television. Unfortunately, such an option requires the manufacturer to depend on store or department personnel playing the demonstration video in lieu of the program signal being broadcast to all other televisions on display. Since most prefer to display the same program, it is unlikely that a demonstration video that is displayed as the primary video would be an ineffective option for calling a consumer's attention to the television's features.

Therefore, it would be desirable to provide systems and methods that facilitate an effective display of product features in a point of purchase environment.

### SUMMARY

Embodiments described herein are directed to improved methods, systems and apparatus for effectively displaying product features in a point of purchase environment to draw the attention of the consumer the manufacturer's television. In one embodiment, the features are stored in memory on the television as individual images or a slideshow and are displayed on the screen as an overlay or secondary video with the primary video, which is typically the display of a common broadcast signal sent to multiple televisions in a store display. The television's on-screen-display (OSD) controller combines the videos for display on the screen. The feature images can be displayed as a group label, as static images that fade in and out, or as a dynamically rolling string of images.

In one embodiment, the controls are set at the factory to display the feature images as a default. Alternatively, this option can be activated through use of a special key on the television's remote control or through the television's menu structure under the “setup” feature. Under the “setup” menu, an operator can select the “demo” feature and then under the “demo” menu the operator can select POP (point of purchase) feature to activate the video display of features.

In one embodiment, the television includes a screen, an on-screen-display controller, a projection or video display system coupled to the screen and the on-screen display (OSD) controller, and a CPU coupled to the OSD controller. The CPU preferably includes a memory such as flash memory devices and feature images stored in the memory in one or more formats including individual images, slide shows, videos or the like, as well as software to control the manner in which the images are displayed on the screen and decode video or other image display formats.

Other objects, systems, methods, features, and advantages of the invention will be or will become apparent to one with skill in the art upon examination of the following figures and detailed description. It is intended that all such additional systems, methods, features and advantages be included within this description, be within the scope of this invention, and be protected by the accompanying claims. It will be understood that the particular methods and apparatus are shown by way of illustration only and not as limitations. As will be understood by those skilled in the art, the principles and features explained herein may be employed in various and numerous embodiments.

### DESCRIPTION OF THE DRAWINGS

The details of the invention, both as to its structure and operation, may be gleaned in part by study of the accompanying figures, in which like reference numerals refer to like parts. The components in the figures are not necessarily to scale, emphasis instead being placed upon illustrating the principles of the invention. Moreover, all illustrations are intended to convey concepts, where relative sizes, shapes and other detailed attributes may be illustrated schematically rather than literally or precisely.

FIG. 1 is a plan view of a conventional television display system in a consumer electronics store or consumer electronics department of a department store.

FIG. 2 is a plan view of a television with a conventional point-of-purchase feature label attached to the face of the television below the screen.

FIG. 2a is a detail plan view taken along line 2a-2a in FIG. 2 and showing a conventional point-of-purchase feature label.

FIGS. 3a-3e are a series of plan views of televisions showing static feature images overlaid over the primary video.

FIG. 4 is a plan view of a television showing a dynamic rolling image of the television features.

FIG. 5 is a schematic of a television control and image display system.

FIG. 6 is a process flow diagram illustrating a menu system used for activation of the POP feature display.

It should be noted that elements of similar structures or functions are generally represented by like reference numerals for illustrative purpose throughout the figures. It should also be noted that the figures are only intended to facilitate the description of the preferred embodiments.

### DETAILED DESCRIPTION

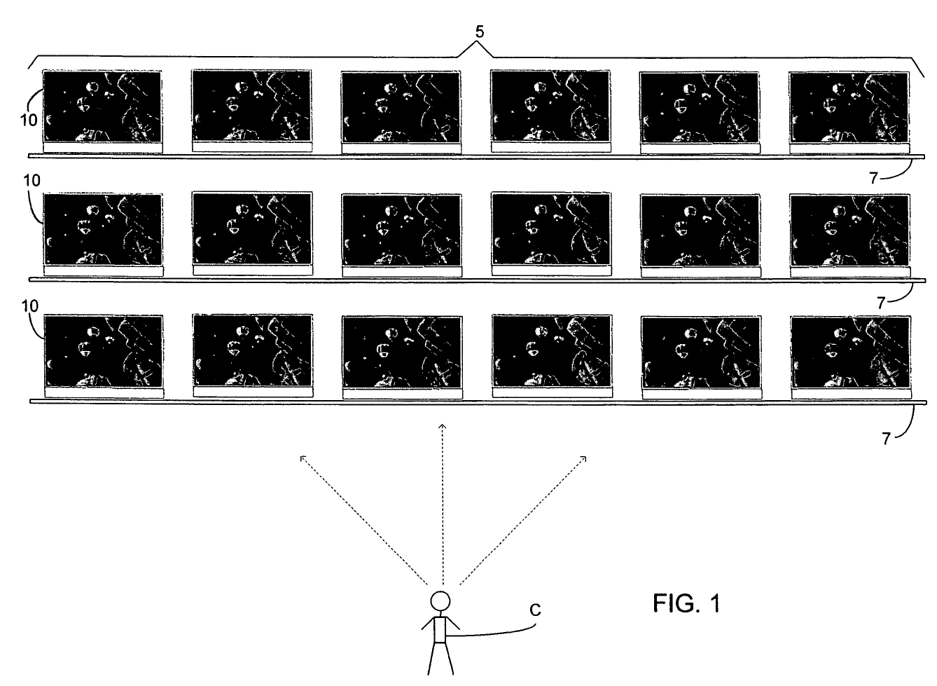

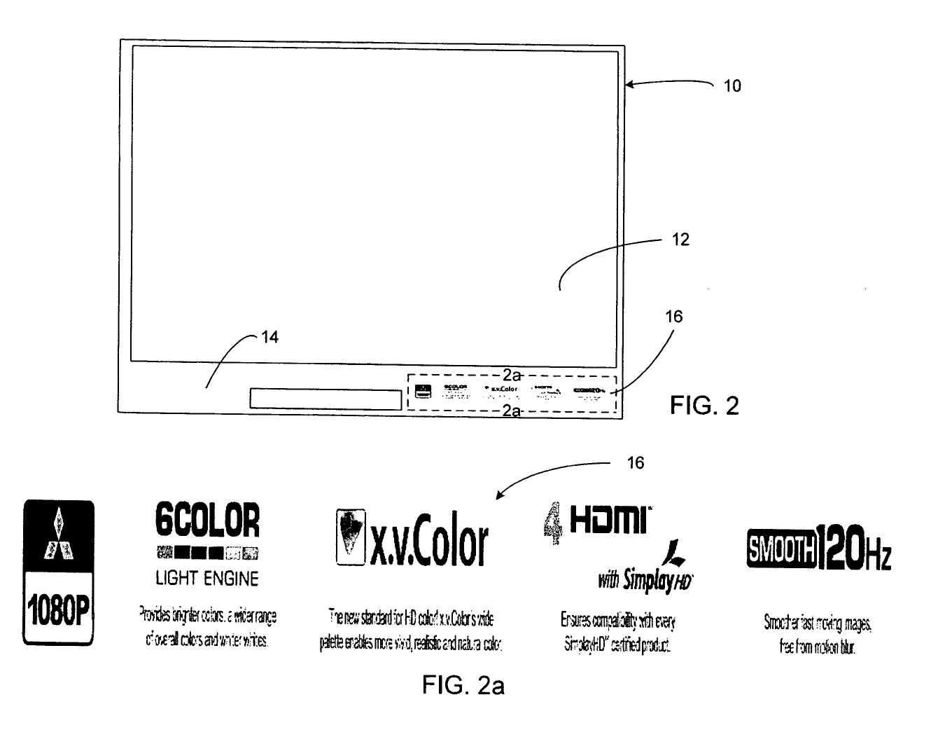

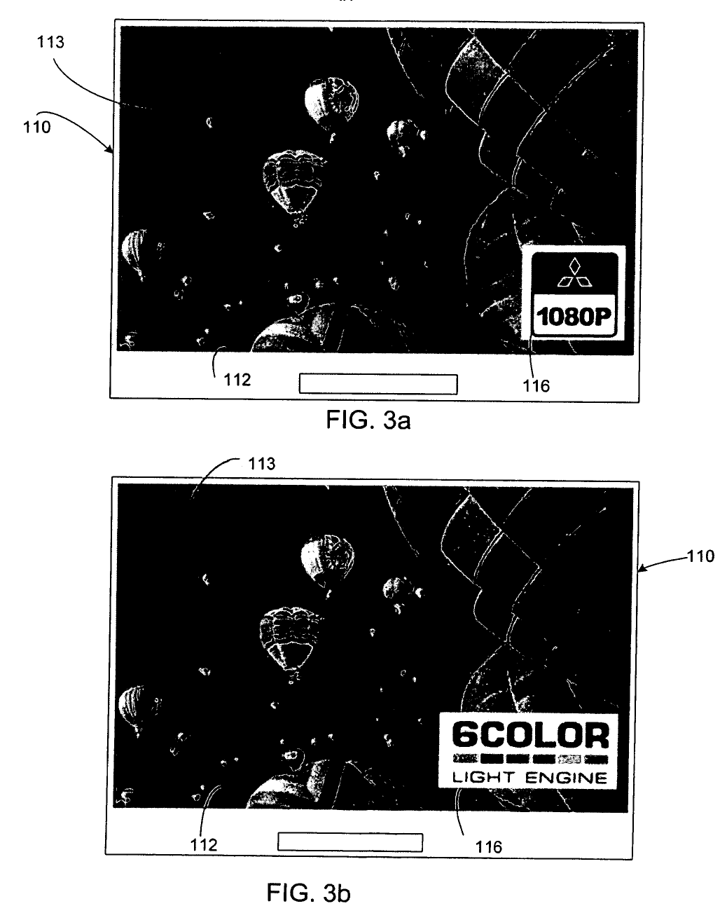

Embodiments described herein are directed to improved methods, systems and apparatus for effectively displaying product features in a point-of-purchase (POP) environment to draw the attention of the consumer to the manufacturer's television and its features. As depicted in FIG. 1, a television display 5 found in a conventional consumer electronics store or in a consumer electronics department of a large department store, typical has televisions 10 from multiple manufactures positioned side by side on multiple display shelves 7. The consumer C typically sees the same program being displayed on each of the televisions 10 as the same program signal is broadcast to each of the televisions 10 by the store or department manager. In order to distinguish their television from the others on display and call to the attention of the consumer C the different features incorporated in their television, manufactures often include a POP feature label 16, as shown in FIG. 2, attached to the face 14 of their television 10 just below the screen 12. As depicted in FIG. 2a, the POP label typically includes the newest, most sought after features of the manufacturer's television, e.g., 1080P, 6 Color, x.v.Color™, 4HDMI™, and Smooth 120 Hz. Creating and applying such labels to each of the manufacturer's televisions is time and labor intensive and, thus, costly, as well as wasteful as previously printed labels become obsolete as new features are added to the manufacturer's television.

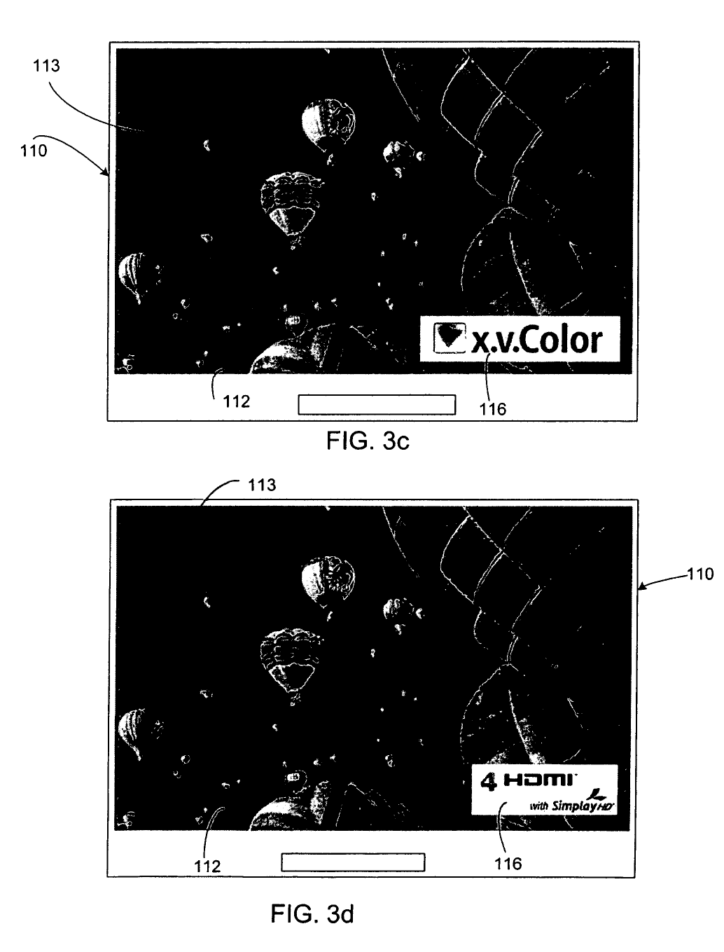

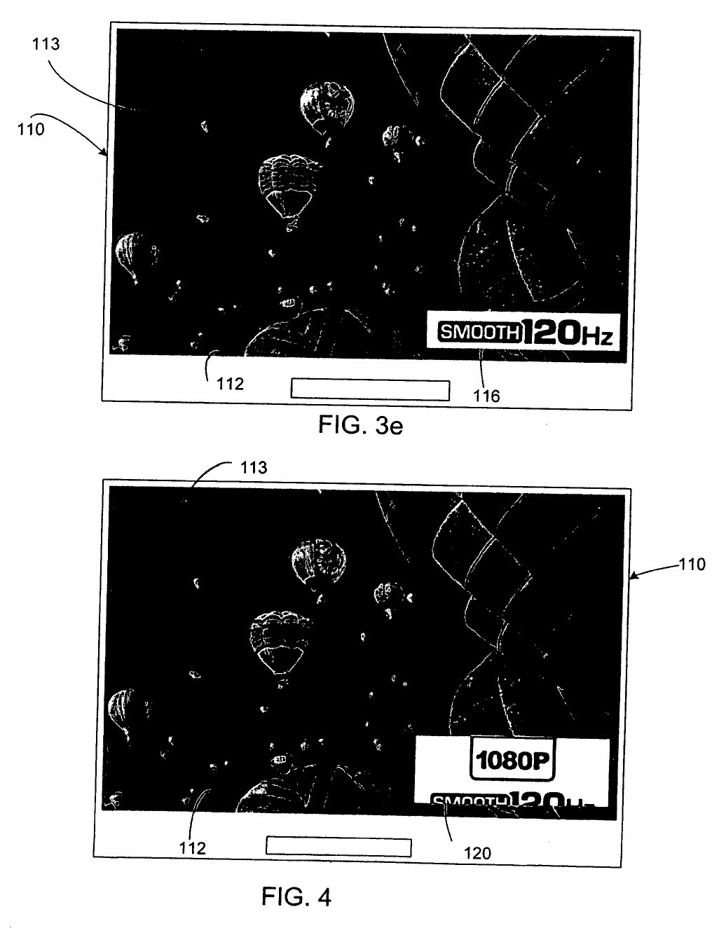

As depicted in FIGS. 3a-3e, in one embodiment, the feature images, which are stored in memory on the television 110, are displayed on the screen 112 as an overlay or secondary video 116 with the primary video 113, which in a POP environment is typically the display of a common broadcast signal sent to multiple televisions in a store display. The feature images can be displayed in the secondary video 116 as a group label or as static images. The feature images can be dynamically displayed by fading out one image while fade in another, or, as depicted in FIG. 4, the secondary video 120 can comprise a rolling string of feature images. The secondary video could comprise a video clip in flash, MPEG-4 HDTV, or other available formats, or comprise a high definition photo slide show, or the like.

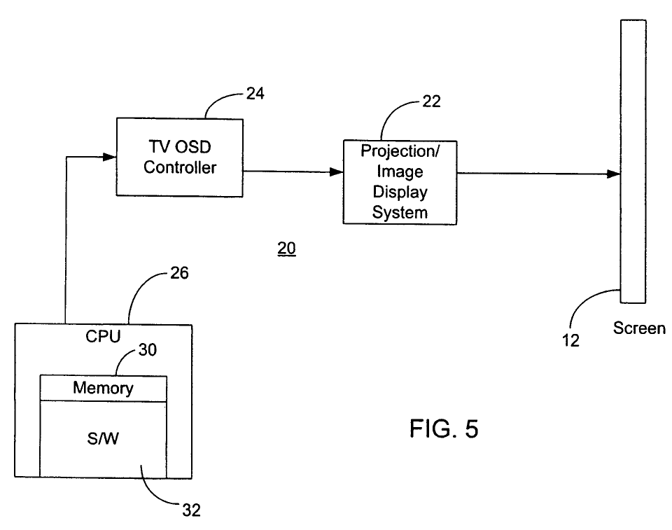

Turning to FIG. 5, a control and image display system 20 of the television includes the screen 12, a projection/image display system 22 coupled to the screen 12, an on-screen-display (OSD) controller 24 coupled to the display system 22 and a CPU 26 coupled to the OSD controller 24. The CPU 26 includes non-volatile memory 30 upon which the feature images are stored. The feature images can be stored as individual images to be pulled up and displayed individually, as a group label to be displayed as a group label, as one or more slide shows, videos, and the like. Also stored in the memory 30 is software 32 which includes a set of instructions for activating or deactivating the POP feature display function, selecting and controlling display mode, instructing the OSD controller 24 to display POP feature images in accordance with the selected display mode, and decoding the video or other display format. The OSD controller 24 then combines the feature images or videos as a secondary video with a primary video on the screen 12 with the secondary video overlaying the primary video.

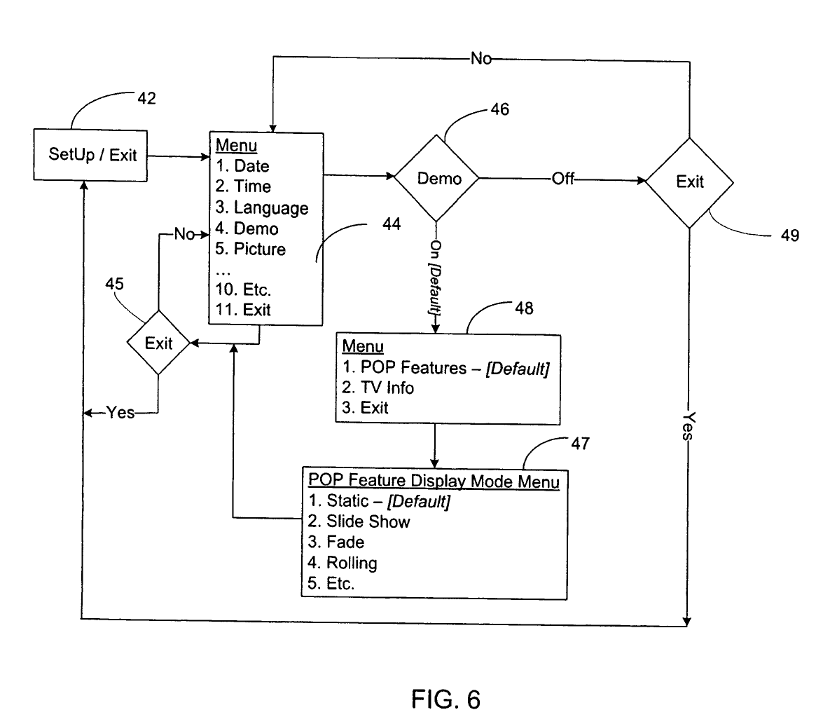

As depicted in FIG. 6, the POP feature display function can be operated through the television's menu structure through the television's on-screen user interface. If an operator selects the “setup” feature 42 when the menu option are displayed, a “setup” menu 44 is displayed on the screen. If the operator selects the “demo” feature in the “setup” menu 44, the operator is presented with a decision 46 of turning the “demo” mode “On” or “Off”. If the operator chooses to turn the demo mode on, which, as shown, can be the default setting when the television leaves the manufacturer's factory, a “demo” menu 48 is displayed from which the operator can select POP (point of purchase) feature to activate the video display of television features. Next, a POP feature display mode menu 47 is displayed to the operator enabling the operator to choose the mode by which the POP feature images are to be displayed. Should the operator choose, the operator could choose to exit the setup menu or the demo menu at blocks 45 and 49.

In the alternative, the POP feature display option can be activated through use of a special key on the television's remote control (not shown).

The particular examples set forth herein are instructional and should not be interpreted as limitations on the applications to which those of ordinary skill are able to apply this device. Modifications and other uses are available to those skilled in the art which are encompassed within the spirit of the invention as defined by the scope of the following claims.

What is claimed is:

1. A method for displaying product features in a point-of-purchase environment having a product demonstration display including a plurality of televisions manufactured by one or more different manufacturers, comprising the steps of
displaying as a primary video on one of the plurality of televisions a program corresponding to a program signal broadcast to each of the plurality of televisions, and
displaying as a secondary video on the one of the plurality of televisions images identifying features of interest incorporated on the one of the plurality of televisions, the secondary video being displayed overlaying the primary video.

2. The method of claim 1 receiving the primary video, decoding the secondary video, and combining the primary and secondary videos for display.

3. The method of claim 1 wherein the secondary video is a static image comprising television feature descriptions.

4. The method of claim 1 wherein the secondary video is a slide show of images comprising television feature descriptions.

5. The method of claim 1 wherein the secondary video is a dynamic video showing a rolling transition of a plurality of images comprising television feature descriptions.

6. A method for displaying product features on a television in a point-of-purchase environment having a product demonstration display including a plurality of televisions manufactured by one or more different manufacturers, comprising the steps of
receiving a primary program signal broadcast to the television to be displayed as a primary video,
decoding a secondary video stored in memory of the television, the secondary video including a plurality of images identifying features of interest incorporated on the television,
combining a secondary program signal corresponding to the decoded secondary video with the primary program signal, and
displaying the primary video on a display screen of the television with the secondary video being displayed overlaying the primary video.

7. The method of claim 1 wherein the secondary video is a static image comprising television feature descriptions.

8. The method of claim 1 wherein the secondary video is a slide show of images comprising television feature descriptions.

9. The method of claim 1 wherein the secondary video is a dynamic video showing a rolling transition of a plurality of images comprising television feature descriptions.

10. A control and image display system for a television comprising
a screen,
a image display system coupled to the screen,
an on-screen-display (OSD) controller coupled to the image display system, and
a CPU coupled to the OSD controller, the CPU comprising non-volatile memory upon which product feature images and a image control software program is stored, the image control software program includes a set of instructions for instructing the OSD controller to display product feature images in combination with a primary video program.

11. The system of claim 10 wherein the software program further comprises instructions for activating or deactivating the display of product feature images.

12. The system of claim 10 wherein the software program further comprises instructions for selecting and controlling display modes of the product feature images.
